(19) United States
(12) Patent Application Publication
(10) Pub. No.: US 2025/0075752 A1
(43) Pub. Date: Mar. 6, 2025

(54) ROLLING BEARING FOR A DISC BRAKE, AND BRAKE CALIPER HAVING A ROLLING BEARING

(71) Applicant: ZF CV Systems Europe BV, Brussels (BE)

(72) Inventor: Roman-Marius Mittendorf, Heppenheim (DE)

(21) Appl. No.: 18/726,456

(22) PCT Filed: Jan. 6, 2022
(86) PCT No.: PCT/EP2022/050178

§ 371 Date: Jul. 3, 2024

(51) Int. Cl. F16D 55/2255; F16D 65/00

(52) U.S. Cl. CPC F16D 55/2255; F16D 65/0068

(57) ABSTRACT

A rolling bearing (10) for a disc brake includes a bearing shell segment (12) and a bearing cage (14) having rolling members (16) that roll on the bearing shell segment (12). The bearing cage (14) is movable in the circumferential direction of the bearing shell segment (12) and releasably fixed in an assembly position in relation to the bearing shell segment (12). The bearing cage (14) has a detent face (22) with at least one recess (24, 24′, 24″), and the bearing shell segment (12) has at least one detent part (20, 20′), the recess (24, 24″) and the detent part (20, 20′) being assigned to one another and mutually engaged in the assembly position while generating a clamping effect.

### FIELD

The present disclosure relates to a rolling bearing for a disc brake, in particular for a compressed-air disc brake, the disc brake having a brake cylinder, a pivot lever which, for driving purposes, is operatively coupled to the brake cylinder, and a thrust piece which is supported on the pivot lever by way of the rolling bearing, having a bearing shell segment and a bearing cage having rolling members that roll on the bearing shell segment, the bearing cage being movable in the circumferential direction of the bearing shell segment and specified to be releasably fixed in an assembly position in relation to the bearing shell segment. The present disclosure furthermore relates to a brake caliper for a disc brake, and to a method for assembling a brake caliper.

### BACKGROUND

Disc brakes of the type described above are generally known in the field of engineering and are usually used in vehicles such as, for example, motor trucks or buses for a braking action on the moving vehicle. The braking action emanates from an activation signal, for example emanating from a brake pedal or an electronic control apparatus of the vehicle. An activating force which by way of a pivot lever is transmitted to a thrust piece that is received so as to be displaceable on a brake caliper is usually generated on a brake cylinder by the activation signal. As the brake is activated, the movable thrust piece interacts with a brake pad of the disc brake, the brake pad moving in the direction of a brake face of a brake disc that rotates during the movement of the vehicle, generating a reactive force as a result of which the brake caliper is displaced until the second brake pad ultimately likewise comes into contact with the rotating brake disc. A frictional force between the brake disc and the brake pad faces, and thus the braking action on the vehicle, is achieved by the faces of the brake pads that act on the brake face.

A rolling bearing is provided between the force-transmitting faces of the pivot lever and the thrust piece, so as to be able to transmit the movement of the pivot lever, which is received so as to be movable on the brake caliper by way of at least one pivot bearing, to the thrust piece without any major loss of force. In order to be able to transmit the force generated by the brake cylinder reliably to the thrust piece, it is essential that the rolling bearing between the pivot lever and the thrust piece is at all times precisely aligned, or positioned, in relation to the force-transmission face on the pivot lever.

If the rolling bearing were not installed in the correct alignment, or position, between the pivot lever and the thrust piece, this could lead to a reduced braking action, this potentially being created by an inadequate alignment or positioning of the rolling bearing between the bearing shell segment and the bearing cage. Therefore, the necessary provisions have to be implemented already when assembling the brake, in order to prevent parts of the rolling bearing from being inadvertently released from one another in such a way that the components are not assembled in the correct position relative to one another.

In order to in particular prevent the rolling member from sliding off from the pivot lever, which particularly interacts with the latter, during assembly, DE 10 2013 211 447 B4 proposed that a holding mechanism are provided on the bearing cage, by way of which the bearing cage is able to be releasably fixed on the bearing shell of the semi-shell bearing. The holding mechanism that project from the bearing cage have latching elements which latch into predetermined regions of the bearing shell. The latching mechanism is cancelled by the first activation of the brake, and the rolling bearing is transferred to its operating position, whereby parts of the holding mechanism can snap off and are thus able to freely move within the rolling bearing. Movable residue of this type is undesirable because this may also potentially lead to the functioning of the brakes being compromised.

### SUMMARY

The present disclosure was therefore based on the object of providing a rolling bearing for a disc brake, a brake caliper, and a method for assembling a brake caliper, with the aid of which the above set of issues are avoided.

According to a first aspect, the present disclosure achieves the underlying object in a rolling bearing for a disc brake. It is provided in particular that the bearing cage has a detent face with at least one recess, and the bearing shell segment has at least one detent part, the recess and the detent part being assigned to one another and specified to be mutually engaged in the assembly position while generating a clamping effect.

According to the present disclosure, instead of the holding mechanism which project from the bearing cage and could break off from the bearing cage upon first activation of the brake when the bearing cage is transferred from its assembly position to its operating position and would then move within the bearing, the approach taken here is now to provide a recess, which is in each case assigned to one detent part on the bearing shell segment, on a detent face of the bearing cage, and to bring the recess and the detent part into a mutual clamping engagement. The dimensions of the recess and of the detent part herein are mutually adapted in such a way that a clamping effect is achieved on the bearing shell segment in the assembly position of the bearing cage, in which the recess on the bearing cage and the detent part on the bearing shell segment interact. The clamping effect of the bearing cage on the bearing shell segment of the rolling bearing is based on a force-fitting connection between the mutually interacting contact faces of the recess and the detent part. In order to achieve the clamping effect, the bearing cage, by way of its recess, is brought into contact with the detent part of the bearing shell segment preferably by way of a predefined force, in particular pushed onto the detent part.

The assembly position of the bearing cage relative to the bearing shell segment is presently understood to mean the position in which the bearing cage, in particular by way of regions of its recess, engages with the detent part on the bearing shell segment while generating the clamping effect. The bearing cage is released from the assembly position on the bearing shell segment by way of the first activation of the brake, and is transferred to its operating position. In the operating position, the bearing cage, by way of its detent face, or the recesses formed thereon, is disposed at a spacing from the detent parts of the bearing shell segment.

According to one preferred design embodiment, the recess has clamping faces that correspond to the detent part for generating the clamping effect, said clamping faces preferably having a width dimension, as measured substantially parallel to the longitudinal axis of the rolling members, which is smaller than the width dimension of the detent part on the bearing shell segment that interacts with the recess. The depth dimension of the recess is presently defined by the spacing dimension between the detent face and the base of the recess. The clamping effect between the recess and the detent part is presently chosen to be only so great that the clamping effect between the recess and the detent part is cancelled by the first activation of the brake, and the bearing cage is transferred from its assembly position to the operating position.

According to a preferred refinement of the rolling bearing, the recess has at least one clamping face that runs at an angle β of approximately 60° to approximately 120° in relation to the detent face for generating the clamping effect conjointly with the detent part. The at least one clamping face of the recess preferably runs at an angle dissimilar to 90° in relation to the detent face. The clamping face forms in particular a wall face that defines the width dimension of the recess. The width dimension of the recess either decreases or increases from the detent face in the direction of the base of the recess. The smallest width dimension of the recess is preferably smaller than the width dimension of the detent part that corresponds to the recess. If the bearing cage is brought to engage with the bearing shell segment, thus moved to its assembly position, a clamping effect is created as a result of the obliquely running clamping face either directly upon the bearing cage being brought into contact with the detent part, whereby the recess widens toward the base, or as the bearing cage is increasingly pushed onto the detent part of the bearing shell segment, whereby the width of the recess decreases toward the base.

According to a preferred design embodiment, the recess has two clamping faces that converge in a wedge-shaped manner in the direction of its base. An improved compensation of potential tolerances arising in the production of the bearing shell segment and the bearing cage is achieved by the design embodiment of two clamping faces on the recess that run obliquely to the base of the recess and form the wall faces of the recess. As opposed to only one obliquely running clamping face, a dual compensation of tolerances is achieved by the two clamping faces that preferably converge in a wedge-shaped manner.

According to a preferred design embodiment of the rolling bearing, the recess is a first recess, and a second recess is provided on the detent face, the second recess preferably having a clearance X in relation to an associated second detent part on the bearing shell segment. In order to be able to transfer the bearing cage to its assembly position on a bearing shell segment having two detent parts, a number of recesses corresponding to the number of detent parts are provided on the bearing cage, in particular on its detent face. According to the present disclosure, at least one of the recesses is specified for generating a clamping effect in the assembly position of the bearing cage.

The other, in particular second, recess in relation to the associated second detent part on the bearing shell segment preferably has a width dimension B₁ which is greater than the width B₂ of the detent part. To create the clearance, the wall faces of the second recess preferably run at a spacing of a few millimeters from the associated wall face of the second detent part. The bearing cage and the bearing shell segment are not in contact in the region of the second recess, which is why potential production tolerances do not have any influence on the clamping effect between the bearing cage and the first detent part. Clamping of the bearing cage in its assembly position thus takes place only by way of one of the recesses formed thereon.

According to a refinement of the rolling bearing, the second recess and the detent part assigned to the second recess are specified to be mutually engaged in the assembly position while generating a clamping effect. As a result of the design embodiment of the two recesses according to the present disclosure, a clamping effect of the first and of the second recess on the bearing cage is achieved conjointly with a respectively associated detent part. The clamping force acting between the bearing shell segment and the bearing cage in the assembly position of the latter can thus be increased. Any unintentional movement of the bearing cage from its assembly position on the bearing shell segment is thus better counteracted.

In its most general embodiment, the second recess in the width direction has a dimension that is smaller than the width dimension of the detent part which interacts with the second recess. In a preferred design embodiment, the second recess, in a manner analogous to that of the first recess, has at least one clamping face that runs at an angle of approximately 60° to approximately 120° in relation to the detent face, with the aid of which the clamping effect is caused on the second detent part. In a particularly preferred embodiment, the second recess has two clamping faces that converge in a wedge-shaped manner in the direction of its base. The spacing of the clamping faces in the proximal region of the detent face is greater than the width dimension of the detent part. The spacing of the two clamping faces on the base of the recess, which converge in a wedge-shaped manner and define the wall faces of the recess, is preferably smaller than the width of the detent part. The spacing between the two clamping faces that converge in a wedge-shaped manner, approximately at half the depth of the recess, preferably corresponds to the width dimension of the detent part.

A potential refinement of the present disclosure provides that formed in the first recess and/or the second recess are two clamping wedges which are disposed at a predetermined mutual spacing and extend from the base of the recess in the direction of the detent face and have a tapered contour. The resilience of the wedge faces on the clamping wedges which implement the clamping effect conjointly with the respectively assigned detent part of the bearing shell segment is increased as a result of the provision of clamping wedges that extend from the base of the recess in the direction of the detent face. The clamping wedges that extend from the base in the direction of the detent face have a height which corresponds approximately to the depth of the recess from the detent face to the base. A wedge-shaped relief which decreases in size from the detent face on the bearing cage in the direction of the base of the recess is provided between a clamping wedge formed in the recess and a respective adjacent wall face of the recess. As a result of the relief formed between the clamping wedge and the wall face of the recess, which runs substantially perpendicularly between the base and the detent face, the clamping wedge can yield in a targeted manner toward the outside, thus in the direction of the wall faces of the recess, when the bearing cage is brought into contact with at least one of the detent parts on the bearing shell segment.

The clamping wedges between their wedge faces that converge in a wedge-shaped manner preferably have an angle in the range from 10° to 60°. The resilience of the clamping wedges can be defined by adapting the wedge angle during the production of the bearing cage, as a result of which the clamping effect between the mutually facing wedge faces of the clamping wedges and the detent part(s) on the bearing shell segment that is/are able to be brought into contact therewith can be influenced in a targeted manner.

According to a preferred refinement, the bearing cage, at least in the region of its recesses formed on the detent face, is formed partially or completely from a composite material. A composite material having a plastic matrix is preferably used. Moreover, a composite material having a plastic matrix has a comparatively high stiffness in comparison to its weight, and can be produced in a cost-effective manner. A fiber-reinforced plastics material is preferably used in the design of at least the region of the bearing cage with its recesses, whereby the plastics material is in particular a thermoplastic plastics material, particularly preferably a polyamide, and whereby the fibers are preferably glass fibers and/or carbon fibers. For example, PA 6.6 with a glass fiber proportion of 20% by weight or more, preferably 25% by weight or more, particularly 30% by weight or more, have proven to be advantageous materials.

In a further aspect, the present disclosure relates to a brake caliper for a disc brake, in particular for a compressed-air disc brake, having a pivot lever which is received so as to be movable on the brake caliper and adjustable by a brake cylinder, and a thrust piece which by way of the pivot lever is movable substantially radially in relation to the pivot axis of the pivot lever.

The present disclosure achieves the object described at the outset in that the brake caliper has a rolling bearing by way of which the thrust piece is supported on the pivot lever, the rolling bearing being designed according to one of the above-described preferred embodiments. In this respect, the present disclosure utilizes the concept that a clamping effect between the contact faces of the recess and the detent part, which are mutually engaged in the assembly position, is achieved by way of the at least one recess formed on the bearing cage, in particular the detent face of the bearing cage, and the detent part on the bearing shell segment that is assigned to the recess. The recess has clamping faces which correspond to the detent part. The recess in terms of its dimensions, in particular in the width direction, is preferably adapted in such a manner that the recess is held in a clamping manner on the bearing shell segment by moving the bearing cage to its assembly position.

The clamping effect is preferably generated between the clamping faces that delimit the recess in the width direction and the component faces that laterally delimit the detent part and preferably run substantially parallel to the clamping faces in the recess. In particular, the width dimension between the clamping faces of the recess, at least along a portion of the clamping face proceeding from the detent face on the bearing cage in the direction of the base of the recess, is smaller than the width dimension of the detent parts on the bearing shell segment. When bringing the bearing cage into contact with the detent part, thus when moving the bearing cage to its assembly position, a clamping effect arises when the respectively mutually facing faces of the recess and the detent part come into contact with one another.

In a further design embodiment of the brake caliper, the recess of the detent face has clamping faces that converge in a wedge-shaped manner in the direction of the base of the recess. In a further design embodiment, two recesses are formed on the bearing cage, of which a first recess is designed in such a way that a clamping effect is generated conjointly with an associated detent part on the bearing shell segment, whereas the dimensions of the second recess are so large that the detent part assigned to the second recess is received with play in the recess.

According to a further aspect, the present disclosure relates to a method for assembling a brake caliper, in particular a brake caliper according to one of the above-described preferred embodiments, the method comprising the following steps: pre-assembling a thrust piece and at least one rolling bearing according to one of the above-described preferred embodiments so as to form a pre-assembled module; moving the bearing cage of the rolling bearing in the circumferential direction on the bearing shell segment during pre-assembly; and establishing contact between the bearing cage and a detent part of the bearing shell segment in such a way that the bearing cage is held in a clamping manner in its assembly position on the bearing shell segment; and installing the pre-assembled module in the brake caliper.

It is effected with the aid of the method steps according to the present disclosure that locking of the bearing cage in its assembly position is effected by clamping the bearing cage relative to the bearing shell segment of the rolling bearing, the bearing cage being reliably held in its assembly position during assembly of the brake caliper and while transporting the latter. The clamping effect between the bearing cage and the detent part on the bearing shell segment is cancelled only by the first activation of the brake, and the bearing cage is transferred to its operating position. A reduced braking action is counteracted in that the rolling bearing is prevented from sliding off relative to the bearing shell segment of the rolling bearing prior to assembly.

The advantages and preferred embodiments described in the context of the rolling bearing according to the present disclosure are also advantages and preferred embodiments of the brake caliper according to the second aspect of the present disclosure and of the method for assembling a brake caliper according to the further aspect of the present disclosure, and vice versa.

The features of the present disclosure disclosed in the description, in the drawings and in the claims can be relevant individually or in any combination with one another in terms of the refinement of the present disclosure, unless they are technically contradictory.

### BRIEF DESCRIPTION OF THE DRAWINGS

The present disclosure will be described in more detail hereunder by way of various exemplary embodiments with reference to the appended figures, in which:

FIG. 1 shows a perspective view of a brake caliper;

FIG. 1 shows a view of a pivot lever which is pivotably received on the brake caliper, and of a thrust piece which is supported thereon by way of a rolling bearing;

FIG. 3 shows a perspective view of a thrust piece and of a rolling bearing according to FIG. 1;

FIG. 4a shows a view of a first embodiment of a bearing cage;

FIG. 4b shows a perspective partial view of a rolling bearing having the bearing cage from FIG. 4a in an assembly position on the bearing shell segment;

FIG. 5a shows a view of a further exemplary embodiment of a bearing cage;

FIG. 5b shows a perspective partial view of a rolling bearing having the bearing cage from FIG. 5a in an assembly position on the bearing shell segment;

FIG. 6a shows a view of a further exemplary embodiment of a bearing cage;

FIG. 6b shows a perspective partial view of a rolling bearing having the bearing cage from FIG. 6a in an assembly position on the bearing shell segment;

FIG. 7a shows a view of a further exemplary embodiment of a bearing cage; and

FIG. 7b shows a perspective partial view of a rolling bearing having the bearing cage from FIG. 7a in an assembly position on the bearing shell segment.

### DETAILED DESCRIPTION

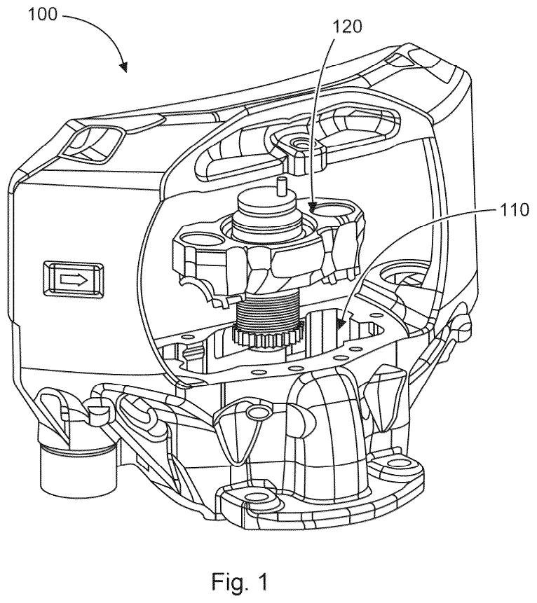

FIG. 1 shows a brake caliper 100 of a disc brake, which is not shown in more detail and usually comprises one pair of mutually spaced apart brake pads likewise not shown, of a vehicle. A brake disc, also not shown in more detail, is disposed between the brake pads. A braking action on the brake disc that rotates in the operation of the vehicle is caused by the converging of the brake pads.

The brake caliper 100 includes a receptacle 110, and furthermore a thrust piece 120 which is insertable into the receptacle 110 and is configured for assembly within the brake caliper and by way of which a compressive force is applied to a rear side of one of the brake pads for converging the brake pads after completing the assembly of the brakes.

Shown in FIG. 2 is a pivot lever 140 which is movably received in the brake caliper 100 not illustrated in more detail, and, for driving purposes, is operatively coupled to a brake cylinder not illustrated in more detail. The pivot lever 140 is mounted within the brake caliper 100 so as to be movable about a pivot bearing 150 with a pivot axis S.

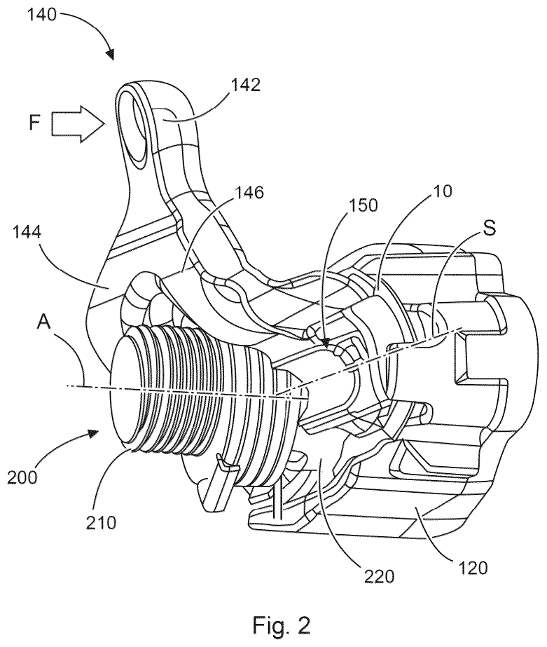

As is furthermore shown in FIG. 2, the pivot lever 140 has a pivot arm 142 on which the brake cylinder operatively engages for driving purposes, the brake cylinder acting in the direction of force F depicted. The pivot lever 140 moreover has two mutually spaced apart shank portions 144, 146 which extend from the pivot arm 142 in the direction of the thrust piece 120. The brake caliper 100 furthermore comprises a readjustment unit 200 which is configured to adjust the play of the brake pad. As can be seen from FIG. 3, the thrust piece 120 has a bore 122 in which the readjustment unit 200 engages by way of an adjustment spindle 210 provided with a corresponding thread.

On the side of the shank portions 144, 146 that face away from the pivot bearing 150, the thrust piece 120 is supported in relation to the pivot lever 140 by way of a rolling bearing 10. If the pivot lever 140 is moved in the direction of the direction of force F shown in FIG. 2 by the brake cylinder not illustrated, the associated pivoting movement of the shank portions 144, 146 is moved to an adjustment movement which is substantially parallel to the adjustment axis A of the readjustment unit 200.

During operation, the pivot lever 140 can also interact with the readjustment unit 200 for adjusting the brake pad position, whereby the movement of the pivot lever 140 interacts with an activation ring assembly 220 and causes the adjustment spindle 210 to rotate about the adjustment axis A.

Each of the two shank portions 144, 146 interacts with a rolling bearing 10, the thrust piece 120 being supported in relation to the latter by way of in each case one concavely curved support face 124. The support faces 124 are designed to be partially cylindrical in relation to the pivot axis S of the pivot bearing. The rolling bearings 10 are disposed on the thrust piece 120 by way of fastening interfaces 126. Each rolling bearing 10 has a bearing shell segment 12 and a bearing cage 14 with rolling members 16 rolling on the bearing shell segments. A hook 18 which engages in each case in one fastening interface 126 on the thrust piece 120 is formed on the bearing shell segment 12. The hook 18 and the bearing shell segment 12 are formed in one piece.

Furthermore, the bearing shell segment 12 has at least one detent part 20 which defines the assembly position for the bearing cage 14, and by way of which the movement of the bearing cage 14 in the circumferential direction of the bearing shell segment 12 is restricted. The bearing cage 14 has a detent face 22 which is in contact with the at least one detent part 20 in the assembly position of the bearing cage 14 and positions the bearing cage relative to the bearing shell segment 12. According to the present disclosure, the intention is to prevent the bearing cage 14 from unintentionally moving out of the assembly position during transportation or during assembly of the brake caliper, for example while inserting the thrust piece 120 into the receptacle 110 provided for this purpose on the brake caliper 100.

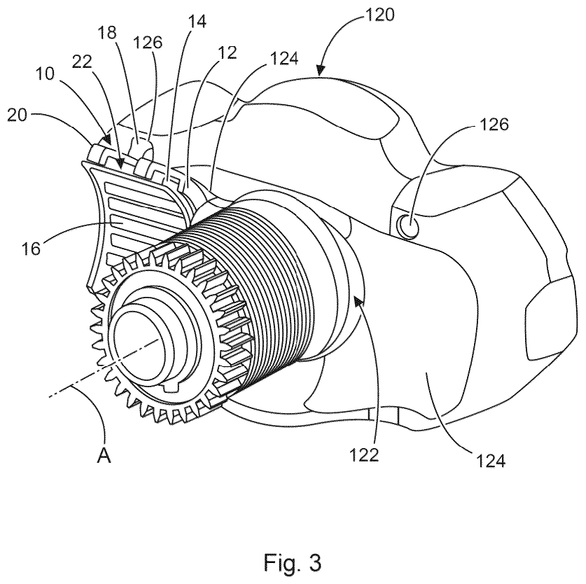

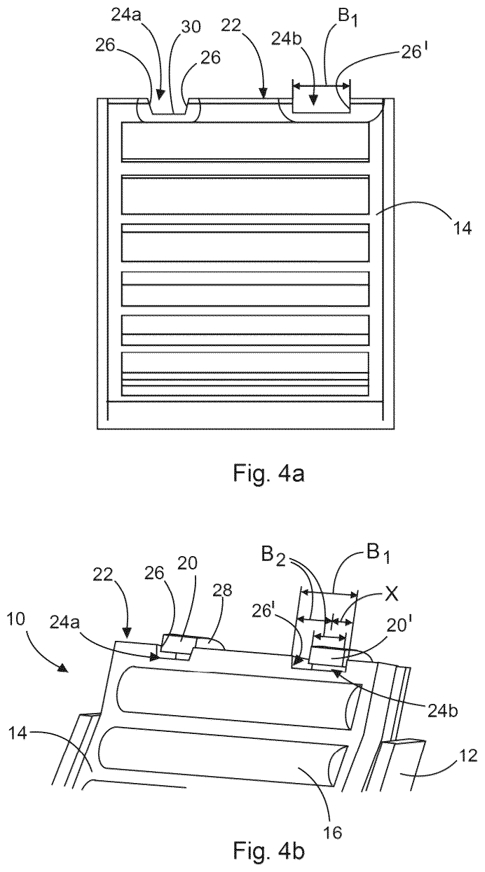

For this purpose, the bearing cage 14 according to a design embodiment shown in FIGS. 4a and 4b has a first recess 24a on the detent face 22, which interacts with the detent part 20 on the bearing shell segment 12, whereby the dimensions of the detent part 20 and of the recess 24a are mutually adapted for generating a clamping effect in the assembly position. In the present embodiment, the recess 24a has at least one clamping face 26, which runs at an angle of approximately 60° to approximately 120° in relation to the detent face 22, for generating the clamping effect conjointly with the contact faces 28 on the detent part 20. In the embodiment shown, the recess 24a has in particular two clamping faces 26 that converge in a wedge-shaped manner in the direction of its base.

As can be seen from FIG. 4b, a clamping effect is thus generated between the recess 24a and the detent part 20 in the assembly position of the bearing cage 14, shown in FIG. 4b, in relation to the bearing shell segment 12.

The bearing cage 14 has, in addition to the first recess 24a, a second recess 24b with a width dimension B1 which, as opposed to the recess 24a, is greater than the width B2 of the detent part 20′ assigned to the recess 24b. The recess 24b has two wall faces 26′ which are disposed at a spacing from the second detent part 20′. The recess 24b has a clearance X in relation to the associated second detent part 20′ on the bearing shell segment 12. The clamping effect in the assembly position of the bearing cage 14 thus takes place exclusively by way of the recess 24a and the detent part 20.

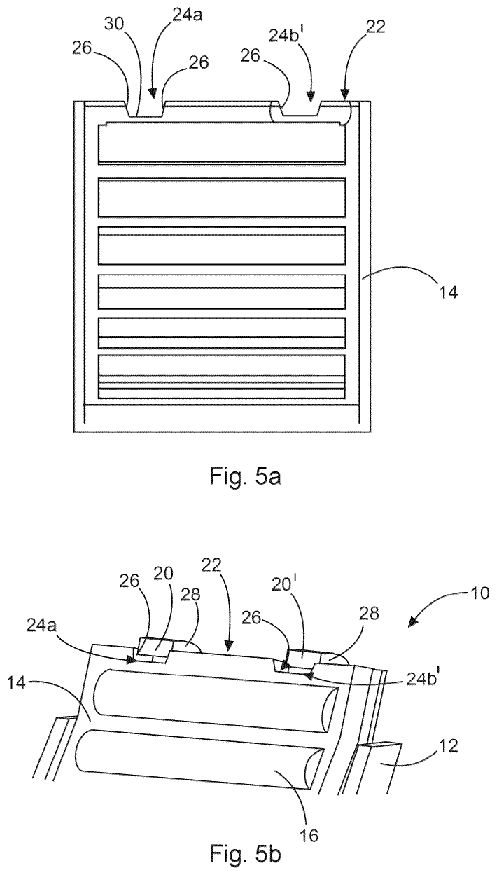

FIGS. 5a and 5b show a further design embodiment of the rolling bearing 10 having its bearing shell segment 12 and its bearing cage 14 and the rolling members 16 encased by the bearing cage. In the embodiment presently shown, the bearing cage 14 has a first recess 24a and a second recess 24b′. Both recesses 24a, 24b′ are specified to generate a clamping effect conjointly with the respectively associated first and second detent part 20, 20′. Both recesses 24a, 24b′ have dimensions which are adapted to the dimensions of the detent parts 20, 20′ in such a manner that a clamping effect is generated when the bearing cage 14 is moved to its assembly position on the bearing shell segment 12, shown in FIG. 5b. Both recesses 24a, 24b′ have in each case two clamping faces 26 which converge in a wedge-shaped manner in the direction of their base and bear along a portion on the detent parts 20, 20′ by way of the contact faces 28.

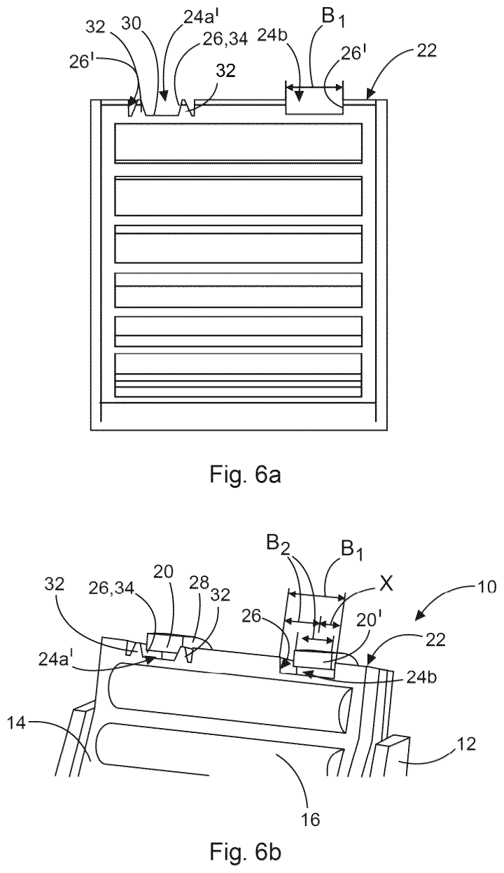

A further design embodiment of a rolling bearing 10 is shown in FIGS. 6a and 6b, which has a bearing cage 14 with a first recess 24a′ on its detent face 22. Two clamping wedges 32 with a tapered contour, which are disposed at a predetermined mutual spacing and extend from the base 30 of the recess 24a′ in the direction of the detent face 22, are formed in the first recess 24a′.

The clamping wedges 32 have wedge faces 34 which, proceeding from the detent face 22, in a manner similar to the clamping faces 26 of the recess 24a, converge in a wedge-shaped manner in the direction of the base 30 of the recess 24a′. The clamping wedges 32 are in each case disposed so as to be spaced apart from the adjacent wall faces 26′ of the recess 24a′.

When clamping the bearing cage 14 in its assembly position on the associated detent part 20 of the bearing shell segment 12, shown in FIG. 6b, the clamping wedges 32 can more easily yield outward in the direction of the wall faces 26. The recess 24a′ is the first recess on the bearing cage 14, and in the embodiment shown the bearing cage 14 has a second recess 24b, the width dimension B₁ of the latter being greater than the width B₂ of the assigned detent part 20′. In this way, there is a clearance X between the second recess 24b and the detent part 20′. Clamping takes place only by way of the recess 24″ on the bearing cage 14 on the detent part 20, which interacts therewith, on the bearing shell segment 12.

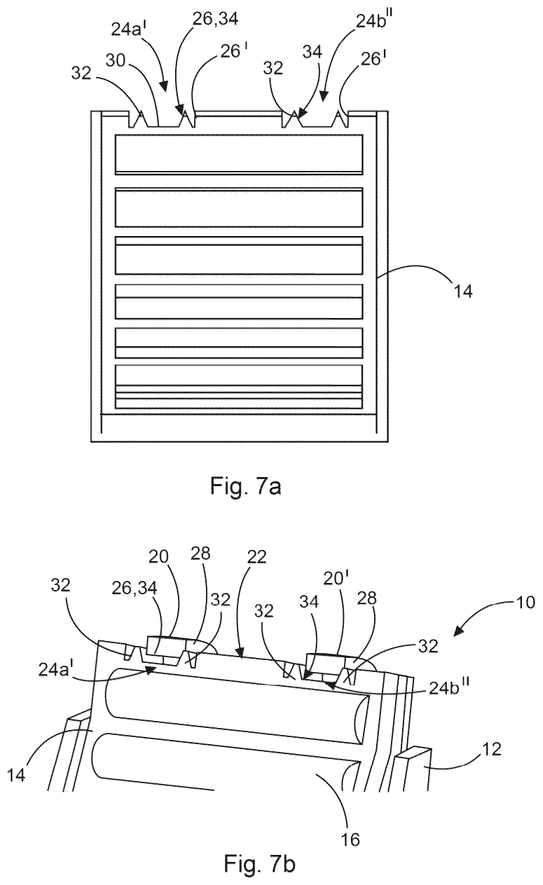

A further design embodiment of the rolling bearing 10, shown in FIGS. 7a and 7b, provides that a first recess 24a′ and a second recess 24b″, which have in each case clamping wedges 32 with a tapered contour extending from the base 30 of the recesses 24a′, 24b″ in the direction of the detent face 22, are formed on the bearing cage 14, in particular on the detent face 22 of the latter. Clamping of the bearing cage 14 in its assembly position (FIG. 7b) takes place by way of the clamping wedges 32 disposed in the two recesses 24a′, 24b″, by way of the wedge faces 34 of said clamping wedges 32 and the detent parts 20, 20′ on the bearing shell segment 12 which interact with said clamping wedges 32.

List of reference signs (part of the description)
10 Rolling bearing
12 Bearing shell segment
14 Bearing cage
16 Rolling member
18 Hook
20, 20′ Detent part
22 Detent face
24a, 24a′ First recess
24b, 24b′, 24b″ Second recess
26 Clamping face
26′ Wall face
28 Contact face
30 Base
32 Clamping wedge
34 Wedge face
100 Brake caliper
110 Receptacle
120 Thrust piece
122 Bore
124 Support face
126 Fastening interface
140 Pivot lever
142 Pivot arm
144, 146 Shank portion
150 Pivot bearing
200 Readjustment unit
210 Adjustment spindle
220 Activation ring assembly
A Adjustment axis
B₁ Width dimension
B₂ Width
F Direction of force
S Pivot axis S
X Clearance

1. A rolling bearing (10) for a disc brake, the disc brake having a brake cylinder, a pivot lever (140) which, for driving purposes, is operatively coupled to the brake cylinder, and a thrust piece (120) which is supported on the pivot lever (140) by way of the rolling bearing (10), the rolling bearing (10) comprising:
a bearing shell segment (12), and
a bearing cage (14) having rolling members (16) that roll on the bearing shell segment (12), the bearing cage (14) being movable in the circumferential direction of the bearing shell segment (12) and releasably fixed in an assembly position in relation to the bearing shell segment (12),
wherein the bearing cage (14) has a detent face (22) with at least one recess (24a, 24a′, 24b, 24b′, 24b″), and the bearing shell segment (12) has at least one detent part (20, 20′), the recess (24a, 24a′, 24b, 24b′, 24b″) and the detent part (20, 20′) being assigned to one another and mutually engaged in the assembly position while generating a clamping effect.

2. The rolling bearing (10) as claimed in claim 1,
wherein the recess (24a, 24a′, 24b′, 24b″) has clamping faces (26) that correspond to the detent part (20, 20′) for generating the clamping effect.

3. The rolling bearing (10) as claimed in claim 1,
wherein the recess (24a, 24a′, 24b′, 24b″) has at least one clamping face (26) that runs at an angle (β) of approximately 60° to approximately 120° in relation to the detent face (22) of the bearing cage for generating the clamping effect conjointly with the detent part (20, 20′) received in the recess.

4. The rolling bearing (10) as claimed in claim 2,
wherein the clamping faces of the recess (24a, 24a′, 24b′, 24b″) comprise two clamping faces (26) that converge in a wedge-shaped manner in the direction of a base (30) of the recess.

5. The rolling bearing (10) as claimed in claim 1,
wherein the recess (24a, 24a′) is a first recess, and a second recess (24b, 24b′, 24b″) is provided on the detent face (22), the second recess (24b) having a clearance (X) in relation to an associated second detent part (20′) on the bearing shell segment (12).

6. The rolling bearing (10) as claimed in claim 1,
wherein the recess (24a, 24a′) is a first recess, and a second recess (24b, 24b′, 24b″) is provided on the detent face (22),
wherein the second recess (24b′, 24b″) and a second detent part (20′) assigned to the second recess are mutually engaged in the assembly position while generating a clamping effect.

7. The rolling bearing (10) as claimed in claim 5,
wherein two clamping wedges (32) are formed in the first recess (24a′) as clamping faces (26) which are disposed at a predetermined mutual spacing and extend from the base (30) of the first recess (24a′) in the direction of the detent face (22) and have a tapered contour.

8. The rolling bearing (10) as claimed in claim 1,
wherein the bearing cage (14), at least in the region of its first and/or second recesses (24a, 24a′, 24b, 24b′, 24b″) formed on the detent face (22), is formed partially or completely from a composite material.

9. A brake caliper (100) for a disc brake, the brake caliper comprising:
a pivot lever (140) which is received so as to be movable on the brake caliper (100) and adjustable by a brake cylinder;
a thrust piece (120) which by way of the pivot lever (140) is movable substantially radially in relation to the pivot axis (S) of the pivot lever (140); and
the rolling bearing (10) as claimed in claim 1, by which the thrust piece (120) is supported on the pivot lever (140).

10. A method for assembling the brake caliper (100) as claimed in claim 9, the method comprising the following steps:
pre-assembling a thrust piece (120) and at least one rolling bearing (10) as claimed in claim 1 so as to form a pre-assembled module;
moving the bearing cage (14) of the rolling bearing (10) in the circumferential direction on the bearing shell segment (12) during pre-assembly; and
establishing contact between the bearing cage (14) and a detent part (20, 20′) of the bearing shell segment (12) in such a way that the bearing cage (14) is held in a clamping manner in its assembled position on the bearing shell segment (12); and
installing the pre-assembled module in the brake caliper (100).

11. The rolling bearing (10) as claimed in claim 6,
wherein two clamping wedges (32) are formed in the first recess (24a′) and the second recess (24b″) as clamping faces (26) which are disposed at a predetermined mutual spacing and extend from the base (30) of the first recess (24a′) and the second recess (24b″) in the direction of the detent face (22) and have a tapered contour.

12. The rolling bearing (10) as claimed in claim 1, wherein the bearing shell segment (12) includes a hook (18) configured for engagement with a fastening interface of the thrust piece.

13. The rolling bearing as claimed in claim 12, wherein the bearing shell segment (12) and the hook (18) as formed in one piece.

14. The rolling bearing (10) as claimed in claim 1, wherein the clamping effect is overcome in response to a first actuation of the pivot lever.

15. The rolling bearing (10) as claimed in claim 14, wherein the bearing cage is moveable to an operating position after the first actuation.
